(19) United States
(12) Patent Application Publication
(10) Pub. No.: US 2020/0195120 A1
(43) Pub. Date: Jun. 18, 2020

(54) MAGNETIC AND ELECTRICAL ENERGY TRANSFORMATION DEVICE

(71) Applicant: Mobile Magnetic Activated Electricity X, New Taipei City (TW)

(72) Inventor: Chien-Chun YU, New Taipei City (TW)

(21) Appl. No.: 16/797,549

(22) Filed: Feb. 21, 2020

Related U.S. Application Data
(63) Continuation-in-part of application No. 16/050,246, filed on Jul. 31, 2018.

(30) Foreign Application Priority Data
Feb. 23, 2019 (TW) 108106188

(51) Int. Cl. H02K 53/00; H02K 5/24; H02K 7/02; H02K 7/116; H02K 11/00; H02K 11/04; H02K 29/03

(52) U.S. Cl. CPC H02K 53/00; H02K 5/24; H02K 7/02; H02K 29/03; H02K 11/0094; H02K 11/044; H02K 7/116

(57) ABSTRACT

The present invention discloses a novel magnetic and electrical energy transformation device, which comprises a control module, to provide operation control of device; a driving motor module, which comprises a driving circuit and a driving motor winding to provide an initial voltage V0 for the operation of the device; a flywheel module, connecting to the driving motor module, rotated by driving motor module and provide stable operation speed of the device; a guiding rotor, disposed around the flywheel module and comprises unidirectional bearing inside the guiding rotor; and, magnetic rotary disc, to generate variation of magnetic flux by rotation for producing induced electromotive force.

### CROSS REFERENCE TO RELATED APPLICATIONS

This application is a Continuation-in-Part of co-pending application Ser. No. 16/050,246, filed on Jul. 31, 2018, for which priority is claimed under 35 U.S.C. § 120; and this application claims priority of Application No. 108106188 filed in Taiwan on Feb. 23, 2019 under 35 U.S.C. § 119, the entire contents of all of which are hereby incorporated by reference.

### TECHNICAL FIELD

The present invention relates to a device for improving the efficiency of magnetoelectric energy conversion, especially relates to the structure design of a rotor of the electric motor and the component structure in which it operates, so as to achieve the purpose of improving the efficiency of magnetoelectric energy conversion.

### BACKGROUND

Electric motor has been the most important core device of industrial automation. It is widely used in various electrical equipment, which main function is to provide mechanical energy or electrical energy, and to drive the external electrical equipment for operation by external work. The electric motor used to perform rotary motion is applied to various industries, office spaces, living spaces, etc., which is almost ubiquitous around our life and surrounding. As for the electric motor used to perform linear motion, it is a well-known linear motor, which is applied to semiconductor industry, automation industry, large machinery and instrument industry, etc.

Conventional electric motor is generally divided into two assemblies: rotor and stator. As well known in the art, the rotor is a rotatable assembly having coils surrounding and available to pass with the current, and the stator is a fixed assembly having magnetic poles to generate magnetic field. Accordingly, the electric motor is fed by external power source, then the current passes through the coils of rotor, thereby generating the magnetic field. The generated magnetic field interacts with the magnetic field provided by the stator, and on the basis of magnetic principle, which is homopolar repulsion and heteropolar adsorption, a rotary motion is performed to drive external electrical equipment finally.

However, although conventional electric motor has been used commonly, many shortcomings are raised and the improvement thereof is required. For example, the conventional motor structure results in a low efficiency of generating mechanical energy due to the frequent of energy transformation is too much often. In addition, based on the conventional structure with rotor surrounded by the coils, it has certain degree of material loss rate, it is not sufficiently at all.

In addition, when the vibration frequency of the rotor of the electric motor is greater than a certain value, it will be expressed in the form of noise, which has a great influence on the performance of the motor. As the electric motor is applied to precision applications such as robotics or electric vehicles, the structure with lower vibration can be considered in the design stage, it can reduce the vibration noise as well as the torque ripple of power output of the electric motor and improve the efficiency of energy conversion.

In view of this, the present inventor has especially reviewed the above issues, and expects to provide a new concept of “Power and Power Cogeneration” and a “ Magnetic and Electrical Energy Transformation Device” which puts this new concept into practice for use by the public. This is indeed a motive for the present invention intended to create.

### SUMMARY OF THE INVENTION

In order to overcome the drawbacks of the prior arts, the invention proposes a magnetoelectric energy conversion device, which comprises a control module to control the operation of the magnetoelectric energy conversion device; a driving motor module including a driving circuit and a driving motor winding to provide the initial voltage V₀ required for the operation of the magnetoelectric energy conversion device; a flywheel module coupled with the driving motor module, wherein an initial voltage V₀ is used to drive the flywheel module for rotating to reduce the impact on the magnetoelectric energy conversion device due to its operation or vibration of external environment; a guide rotor arranged around the flywheel module, installed on a guide shaft, with unidirectional bearing inside the guide rotor, so that the rotation direction of the flywheel module is consistent; a magnetic rotary disc driven by the driving motor module to change magnetic flux surrounding the magnetic rotary disc of rotating; and a drive shaft module transmitting the mechanical energy of the magnetic rotor to an electric motor module.

According to one aspect of the invention, the driving motor module can be three-phase winding or two six-phase winding based on various applied rotating speed range and the corresponding output torque. In the preferred embodiment of the invention, the driving motor module can be six-phase winding formed by two sets of three-phase winding in parallel. When the driving motor module needs a relatively stable high rotating speed, the six-phase winding made by the two sets of three-phase winding can be used to provide electric energy and improve the conversion efficiency of the magnetoelectric energy conversion device.

In the invention, the flywheel module comprises a plurality of flywheels, a transmission disc and a rotating shaft. The flange of the flywheel can be flat or has meshed teeth according to the demand of the application, and is set on the rotating shaft. When the driving motor module operates, the mechanical energy is transmitted to the flywheel module through a transmission belt, reducing the impact of vibration on the magnetoelectric energy conversion device, making the magnetic rotary disc operate stably, so as to improve its energy conversion efficiency.

The magnetic rotary disc comprises a metal rotary body and a plurality of magnetic elements. The metal rotary body is formed by metal, and the magnetic elements arranged on peripheral edge of the metal rotary body in a uniform distribution. Each of the magnetic elements respectively comprises a first magnetic pole portion and a second magnetic pole portion, and the first magnetic pole portions and the second magnetic pole portions respectively belong to upper portion and lower portion of the magnetic elements. Wherein the lower side of the second magnetic pole portion of any magnetic elements and the upper side of the first magnetic pole portion of the other magnetic elements partially attract with each other, so that only the magnetic force lines of the first magnetic pole portions are retained outside the peripheral edge of the metal rotary body.

In a preferred embodiment of the present invention, the peripheral edge of the metal rotary body comprises a plurality of slots in corresponding number, so that the attraction of the magnetic elements is provided. The metal rotary body is a circular disc or a circular ring. The amount of the magnetic elements is 2×3 N or 6×N, wherein N is a positive integer between 1 and 16. The magnetic elements are sheet structure having a curvature. The first magnetic pole portion and the second magnetic pole portion of the magnetic elements respectively occupy a half thereof.

In a preferred embodiment of the present invention, if the first magnetic pole portions are N pole, the second magnetic pole portions are S pole, whereas if the first magnetic pole portions are S pole, the second magnetic pole portions are N pole. The upper side of the first magnetic pole portion of any magnetic elements and an additional magnetic element further attract each other, so as to concentrate magnetic force nearby. The first magnetic pole portion of the additional magnetic element further comprises a magnetic force concentration portion and an inclined surface where the magnetic force concentration portion is arranged on. The metal rotary body comprises iron.

The magnetic rotary disc provided by the present invention has its own characteristics of permanent magnetism and can directly interact with the external magnetic field to perform magnetic poles interaction, so that the coils passed through the current can be omitted to generate a magnetic field. In addition, based on only the first magnetic pole portions exposed outside the peripheral edge of the metal rotary body and the magnetic elements arranged on peripheral edge of the metal rotary body in a uniform distribution, a magnetic field with single magnetic pole and uniformly distributed will be generated outside the peripheral edge of the metal rotary body. The magnetic rotary disc only needs extremely small electric energy supply, then high-efficiency magnetic poles interaction with external magnetic fields can be achieved. In other words, through the magnetic rotary disc provided by the present invention, it is only required a very small amount of electric energy to generate a great amount of mechanical energy, and the mechanical energy can generate electric energy more efficiently, thereby implementing the new concept of new concept of “Power and Power Cogeneration”.

### BRIEF DESCRIPTION OF THE DRAWINGS

The present invention can be understood by utilizing several preferred embodiments in the specification, the detailed description and the following drawings. The same element symbols in the drawings refer to the same elements in the present invention. However, it should be understood that all preferred embodiments of the present invention are only used for illustrative purposes, and not intended to limit the scope of the application.

FIG. 1 shows a functional diagram of a magnetoelectric energy conversion device of the present invention.

FIG. 2 shows two sets of high and low voltage current transmission systems with high-low voltage power supply of the present invention.

FIG. 3 shows the high-low voltage power supply.

FIG. 4A shows the component structure of the flywheel module and the magnetic rotor, wherein the flywheel module is arranged under of the magnetic rotor in the form of concentric circle.

FIG. 4B shows the structure of the magnetic rotor and the guide rotor of the present invention.

FIG. 4C is a top view of the flywheel module of one embodiment of the present invention.

FIG. 5 shows the structure of the drive shaft module of the present invention.

FIG. 6 is a three-dimensional view of the magnetic rotor of the present invention.

FIG. 7 is a three-dimensional decomposition view of the magnetic rotor of the present invention.

FIG. 8 is a three-dimensional view of the magnetic rotary disc of the present invention.

FIG. 9 is a top view of the magnetic rotary disc.

FIG. 10 is the first partial three-dimensional view of the magnetic rotary disc of the present invention.

FIG. 11 is the first partial cross-sectional view of the magnetic rotary disc of the present invention.

FIG. 12 is the second partial cross-sectional view of the magnetic rotary disc of the present invention.

FIG. 13 is the third partial cross-sectional view of the magnetic rotary disc of the present invention.

FIG. 14 is the second partial three-dimensional view of the magnetic rotary disc of the present invention.

FIG. 15 is the fourth partial cross-sectional view of the magnetic rotary disc of the present invention.

FIG. 16 is a schematic view of the operation of the magnetic rotor of the present invention.

### DETAILED DESCRIPTION

In order to give examiner more understanding of the features of the present invention and advantage effects which the features can be achieve, some preferred embodiments of the present invention will now be described in greater detail. However, it should be recognized that the preferred embodiments of the present invention are provided for illustration rather than limiting the present invention. In addition, the present invention can be practiced in a wide range of other embodiments besides those explicitly described, and the scope of the present invention is not expressly limited except as specified in the accompanying claims.

The purpose of the invention is to improve the problem of poor power conversion of the electric motor. Although an external power source can be provided power for the electric motor and the coil of the rotor is powered with current to generate a magnetic field, the induction electromotive force is generated by the magnetic field and the external coil, and then the mechanical energy generated by the external work is inefficient. Therefore, the invention provides a magnetoelectric energy conversion device is applied by an initial voltage V₀ or initial kinetic energy through the external power source to drive the rotation of a magnetic rotary disc in the magnetoelectric energy conversion device. Because the magnetic rotary disc has an optimized circular stacking structure, the magnetoelectric energy conversion device has a good energy conversion efficiency in the process of converting magnetic energy to electrical energy. In addition, it is known that due to the lack of relevant stable structure in the motor, and therefore the performance of the electric motor may be affected by stronger vibration during operation and the electric energy output is unstable due to the increase of torque ripple. In the invention, by optimizing the stable structure of the magnetoelectric energy conversion device, the torque ripple is reduced, and the efficiency of magnetoelectric energy conversion is improved. The detailed descriptions are as follows.

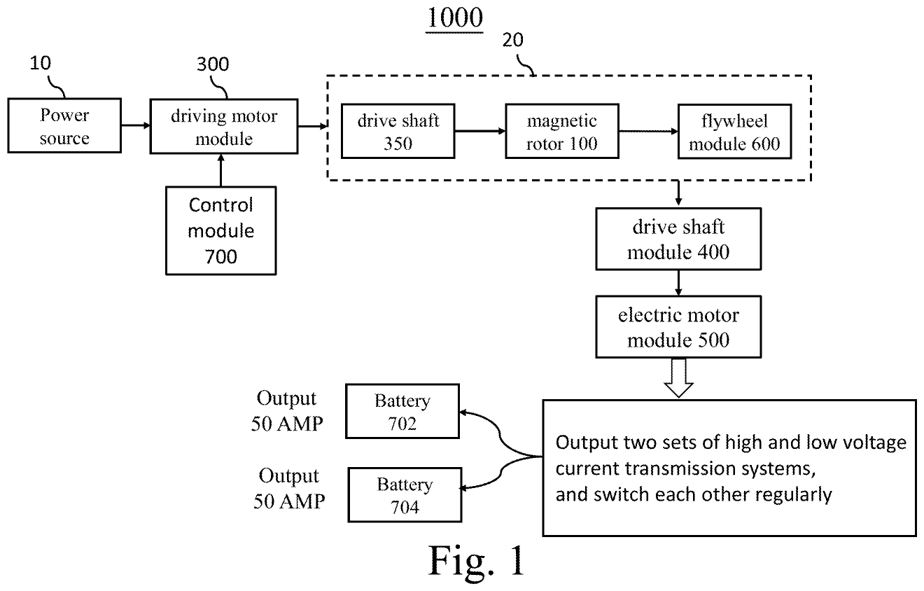

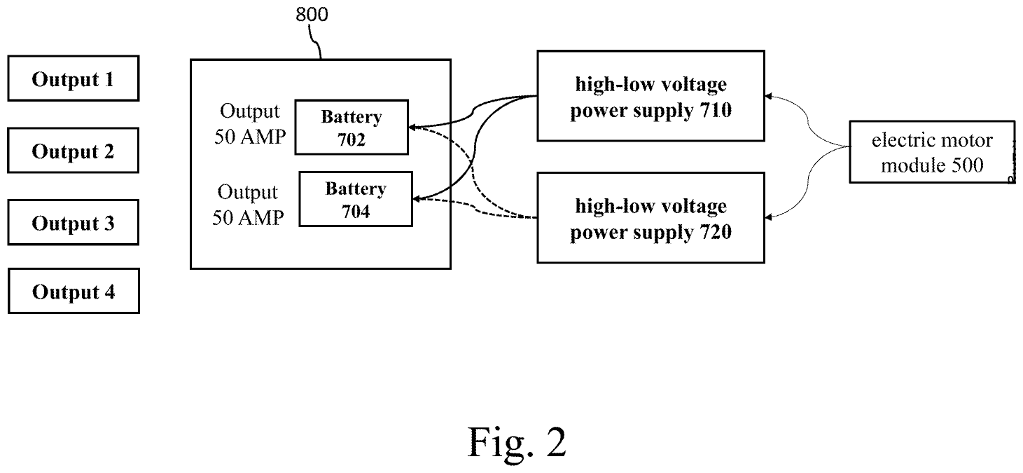

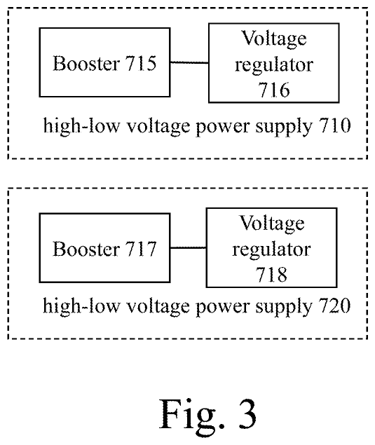

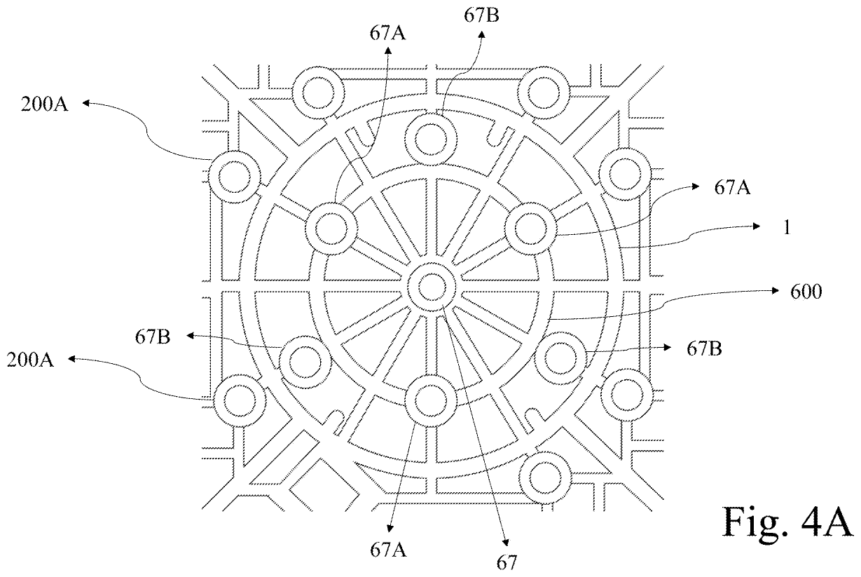

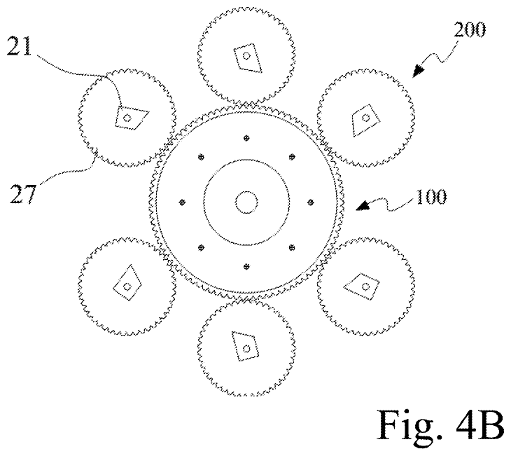

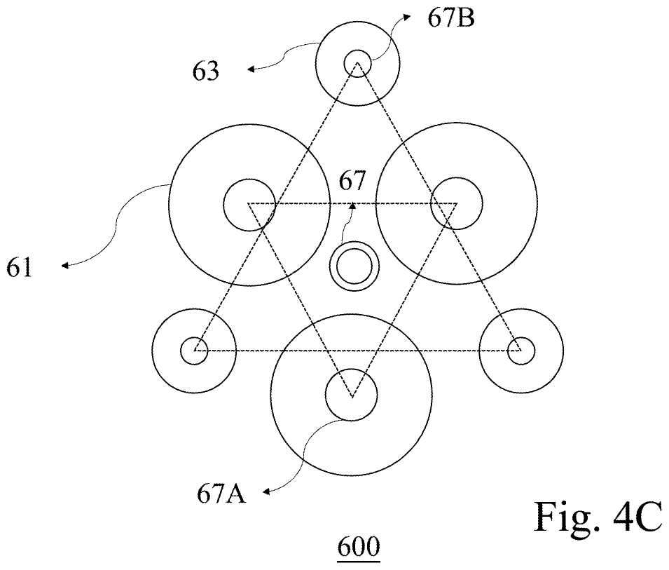

Based on the above purpose, please refer to FIG. 1, FIG. 2, FIG. 4A and FIG. 4B, the invention proposes a magnetoelectric energy conversion device 1000, which includes a voltage power supply 10, an magnetic rotating device 20, a guide rotor 200, a driving motor module 300 a flywheel module 600 and a control module 700. A power supply 10 is electrically coupled to the driving motor module 300, and the driving motor module 300 is electrically coupled to the magnetic rotating device 20. The power supply 10 is for example a battery with 24V voltage, feeding into the driving motor module 300. The driving motor module 300 is electrically coupled to the magnetic rotating device 20 and the control module 700. The magnetic rotating device 20 includes a magnetic rotor 100, a drive shaft 350 and a flywheel module 600. The drive shaft 350 has for example four shafts for driving the magnetic rotor 100. The control module 700 is used to control the operation of the magnetoelectric energy conversion device 1000. The driving motor module 300 includes a driving circuit to provide the initial voltage V₀ required for the operation of the driving motor winding. The flywheel module 600 is coupled to the driving motor module 300 to drive the flywheel module 600 for rotating and provide the stable operating speed of the magnetic rotor 100, or directly or indirectly drive the flywheel module 600 through the magnetic rotor 100. The flywheel radius of the flywheel module 600 can be adjusted according to the demand. The guide rotor 200 is arranged around the flywheel module 600, and is installed on the guide shaft 200A, and is internally provided with a unidirectional bearing to make the rotation direction of the flywheel module 600 identical. FIG. 3B shows the configuration structure of the guide rotor 200, and the radius of the guide rotor 200 can be adjusted according to the demand. The magnetic rotor 100 includes a magnetic rotary disc 1, which is rotated due to the interaction between the magnetic rotor 100 and the guide rotor 200 to produce rotating mechanical energy. The rotation of the magnetic rotary disc 1 makes the change of magnetic flux to produce induced electromotive force E. The drive shaft module 400 transmits the rotating mechanical energy to the electric motor module 500. That is, the rotating mechanical energy of the magnetic rotor 100, the drive shaft 350 and the flywheel module 600 are transferred to the electric motor module 500 through the drive shaft module 400. In one preferred embodiment of the invention, the driving motor module 300 can be a six-phase winding formed by two sets of three-phase winding in parallel. When the driving motor module needs large torque and low rotating speed, one set of the three-phase winding provides electric energy to the flywheel module; while when the driving motor module needs relatively stable high rotating speed, the six phase winding formed by the two sets of three-phase winding provides electric energy to improve the conversion efficiency of the magnetoelectric energy conversion device.

In another embodiment of the invention, the driving motor module 300 includes a driving circuit including several power transistors switches. According to the control signal fed by the control module 700, the phase of the first voltage Vₐ₀, the second voltage V_{b0} and the third voltage V_{c0} are adjusted to control the rotation speed of the driving motor winding, so that the magnetic rotor 100 can be operated by a stable initial voltage V₀ during the operation. The cogging torque that may be generated during the operation of the magnetic rotor 100 due to the instability of the initial voltage V₀ is avoided such that the energy conversion efficiency of the magnetoelectric energy conversion device 1000 does not be reduced. In this embodiment of the invention, the power transistors switches can be, but not limited to, Schottky diodes, fast recovery diodes, and line-frequency diodes, wherein the first voltage Vₐ₀, the second voltage V_{b0} and the third voltage V_{c0} are fed into the first phase voltage Vₐ, the second phase voltage V_{b} and the third phase voltage V_{c} of the driving motor winding, and the initial voltage V₀, according to basic electricity, its mathematical relationship is as follows:

$$[ \begin{matrix}{δ}_{11}^{--} & {δ}_{12}^{--} & {δ}_{13}^{--} \\ {δ}_{21} & {δ}_{22} & {δ}_{23} \\ {δ}_{31} & {δ}_{32} & {δ}_{33}\end{matrix} ] [ \begin{matrix}{V}_{a 0} \\ {V}_{b 0} \\ {V}_{c 0}\end{matrix} ] = [ \begin{matrix}{V}_{a} \\ {V}_{b} \\ {V}_{c}\end{matrix} ]$$

$${V}_{0} = {V}_{a 0} + {V}_{b 0} + {V}_{c 0} ;$$

Wherein, δ₁₁, δ₁₂, δ₁₃, δ₂₁, δ₂₂, δ₂₃, δ₃₁, δ₃₂, δ_{×}are phase factors of the first voltage Vₐ₀, the second voltage V_{b0} and the third voltage V_{c0} respectively. In another embodiment of the invention, the phase factor can be adjusted by the control module 700 according to the feeding conditions of the first voltage Vₐ₀, the second voltage V_{b0} and the third voltage V_{c0}, so as to speed up or slow down the driving motor winding 33, maintain the stability of the initial voltage V₀, reduce the torque ripple without reducing the energy conversion efficiency of the magnetoelectric energy conversion device 1000.

In the invention, the magnetoelectric energy conversion device 1000 has a flywheel module 600. The purpose of the flywheel module 600 of the present invention is used to correct the operation error caused by gravity and vibration of the gear element. The reason why the magnetoelectric energy conversion device 1000 has high efficiency in the conversion of magnetic energy, electric energy and mechanical energy is that the magnetic rotor 100 can operate according to the speed set by the control module 700. As the action of the magnetic rotor 100 itself is not accurate enough, the efficiency of energy conversion will be reduced no matter how the structure of the magnetic rotor 100 is set. Therefore, the invention performs the operation of the flywheel module 600. When the magnetic rotor 100 is affected by the vibration in a certain direction, or the position of the magnetoelectric energy conversion device 1000 itself loses the state of being parallel to the ground, the corresponding position will return to the original state of being parallel to the ground due to the conservation of angular momentum, and the influences in various directions will cancel each other. Thus, the effect of external force is minimized to maintain the stable operation of the magnetoelectric energy conversion device 1000. In addition, the flywheel in the flywheel module 600 can store mechanical energy in the form of rotational kinetic energy when rotating. When the input mechanical energy increases, the rotational speed of the flywheel increases. Relatively, when the flywheel needs to work on the environment, its rotational speed decreases and releases mechanical energy. Therefore, because the flywheel tends to resist the change of rotation speed, when the magnetic rotor 100 rotates, the flywheel can be used as a component to stabilize the rotation speed of the magnetic rotor 100 and make its operation more smoothly.

As mentioned above, the rotating mechanical energy of the magnetic rotor 100, the drive shaft 350 and the flywheel module 600 are transferred to the electric motor module 500 through the drive shaft module 400. The energy generated by the electric motor module 500 can output to two sets of high and low voltage current transmission systems, and switch each other regularly. For example, as shown in FIG. 2, it illustrates two sets of high and low voltage current transmission systems with high-low voltage power supply of one embodiment. The electric motor module 500 is providing power to a high-low voltage power supply 710 and a high-low voltage power supply 720 which provide power to a battery system 800. The high-low voltage power supply 710 and the high-low voltage power supply 720 can provide a high voltage power and a low voltage power to a battery 702 and a battery 704. For example, the high-low voltage power supply 710 and the high-low voltage power supply 720 can provide a high voltage power and a low voltage power to the battery 702 and the battery 704 in timing mutually switching by the control module as shown in FIG. 3, and thereby outputting output 1, output 2, output 3 and output 4. For example, the high voltage is 26.5 V voltage and the low voltage is 24 V voltage. The battery 702 and the battery 704 are outputting a 50 ampere current. In one example, high-low voltage power supply 710 and the high-low voltage power supply 720 includes a booster (boost circuit) 715, 717 and a voltage regulator 716, 718 respectively coupled to the booster 715 and 717 to output a stable voltage. The booster may be a motor-booster, an Entz booster. As battery power of the first battery 702 is less a pre-determined value, the high-low voltage power supply 710 or the high-low voltage power supply 720 is providing power to the first battery 702 for charging, while the second battery 704 is output a stable voltage. In addition, as battery power of the second battery 704 is less a pre-determined value, the high-low voltage power supply 710 or the high-low voltage power supply 720 is providing power to the second battery 702 for charging, while the first battery 702 is output a stable voltage. In one embodiment, the operating range of the booster is 0-99 volts.

Please refer to FIG. 4A and FIG. 4C. In one embodiment of the invention, the flywheel module 600 includes a first stage flywheel 61, preferably three flywheels, which is arranged under (at the lower side of) the magnetic rotor 100 and rotating through a first rotating shaft 67a; a second stage flywheel 63, preferably three flywheels, which is arranged under (at the lower side of) the magnetic rotor 100 and rotating through a second rotating shaft 67b. The first stage flywheel 61 and the second stage flywheel 63 are arranged on the first rotating shaft 67a and the second rotating shaft 67b in a concentric circle structure. In an embodiment, the first rotating shaft 67a and the second rotating shaft 67b are respectively arranged on different concentric circles, thus forming the first stage flywheel group and the second stage flywheel group. It should be noted that the first stage flywheel 61 and the second stage flywheel 63 may be referred to as the flywheel module 600, and the number of the flywheel module 600 may have different numbers and object dimension such as diameter, according to the demands of the application. In the first embodiment of the present invention, the rotating shaft 67a and the rotating shaft 67b are connected by a transmission mechanism, such as a belt or a gear set, to the driving motor module 300, which drives the rotating shaft 67a and the rotating shaft 67b to rotate, and individually or simultaneously, directly or indirectly drives the first stage flywheel 61, the second stage flywheel 63 and the magnetic rotor 100 to rotate. In the second embodiment of the present invention, the transmission belt is connected to the driving motor module 300 to drive the first stage flywheel 61 and/or the second stage flywheel 63 for rotating, and thereby driving the magnetic rotor 100 for rotating. In the third embodiment of the present invention, the transmission belt is connected to the driving motor module 300, and transmits the mechanical energy to the magnetic rotor 100, so that the magnetic rotor 100 can drive the first stage flywheel 61 and the second stage flywheel 63 to rotate. In addition, please refer to FIG. 4A, in a preferred embodiment of the invention, a plurality of guide rotors 200 are arranged around the flywheel module 600 and the magnetic rotor 100, and a unidirectional bearing is arranged inside of the guide rotor, so that the magnetoelectric energy conversion device 1000, including each gear element of the magnetic rotor 100 and the flywheel module 600, will not generate the inverse motion due to the inertia during the operation (that is, to ensure the rotation direction in a single direction) to avoid affecting the stability of the rotation of the gear element. In one aspect of the invention, although the flywheel can make the magnetoelectric energy conversion device 1000 stable under the influence of vibration in operation, many flywheels configuration may make the rotational inertia of each gear component in the magnetoelectric energy conversion device 1000 too large, and thereby affecting the efficiency of energy conversion. Therefore, in the embodiment of the invention, the preferred application configuration of the flywheels is 1-6, so as to make the magnetic energy conversion device 1000 have the best balance between the efficiency of energy conversion and the stability of operation.

In another embodiment of the invention, the flywheel in the flywheel module 600 is arranged under the magnetic rotor 100, meshed with the rotating shaft 67 through the teeth on the wheel rim, and the magnetic rotor 100 is arranged on the rotating shaft 67, so that the flywheel module 600 can be rotated together with the magnetic rotor 100 through the rotating shaft 67. Preferably, the number of the flywheels can be a multiple of three. In the first embodiment, the rotating shaft 67 is connected with the driving motor module 300 through a transmission belt, which drives the rotating shaft 67 to rotate, and simultaneously drives the flywheel and the magnetic rotor 100 to rotate. In the second embodiment, the transmission belt is connected with the driving motor module 300, which drives the flywheel to rotate and drives the magnetic rotor 100 to rotate. In the third embodiment, the transmission belt is connected with the driving motor module 300, and the mechanical energy is transmitted to the magnetic rotor 100, so that the magnetic rotor 100 can drive the flywheel to rotate together.

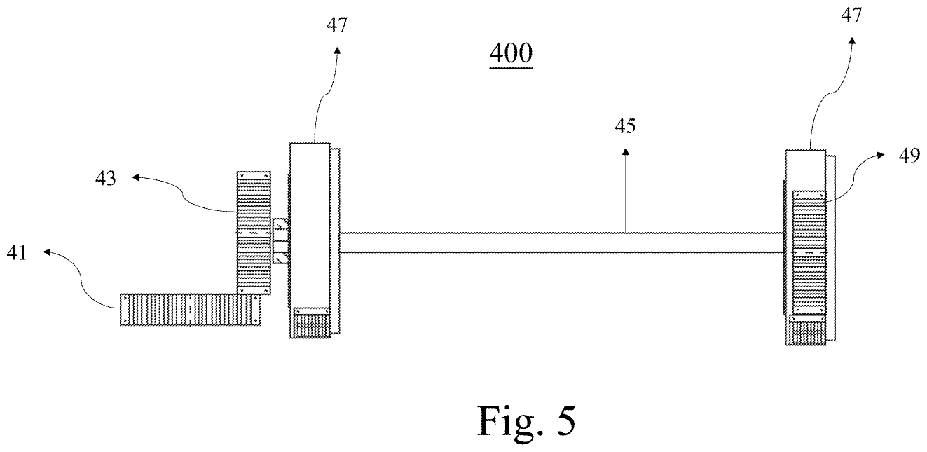

In addition, please refer to FIG. 5. In the embodiment of the invention, the magnetoelectric energy conversion device 1000 has a drive shaft module 400 connected with the above-mentioned magnetic rotor 100. The drive shaft module 400 includes a second gear 43, which is arranged on a drive bracket 47, and a drive shaft 45 is connected with the second gear 43 and the drive wheel 49. When the second gear 43 is driven by the above-mentioned magnetic rotor 100, the mechanical energy through rotating of the drive shaft 45 may transmit to the drive wheel 49 provided on the other drive bracket 47.

In addition, in the above-mentioned embodiments, the drive shaft module 400 may include at least one first gear 41, which is coupled with the second gear 43 and the flywheel module 600. When the flywheel module 600 is placed under (at the lower end of) the drive shaft module 400, the first gear 41 can be installed on the rotating shaft 67, so that the first gear 41 and the second gear 43 can be mutually perpendicularly installed, and the configured space of the magnetoelectric energy conversion device 1000 can be saved in the horizontal direction.

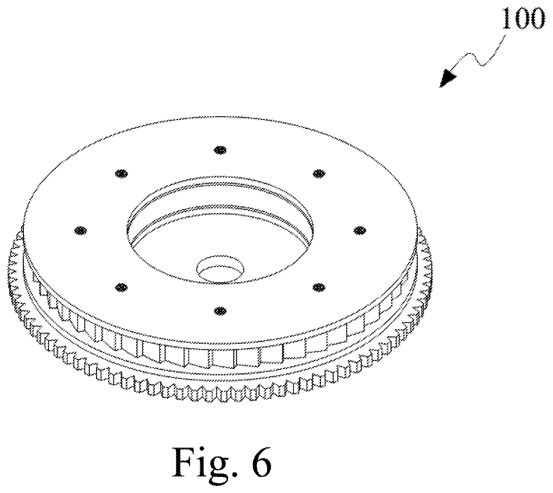

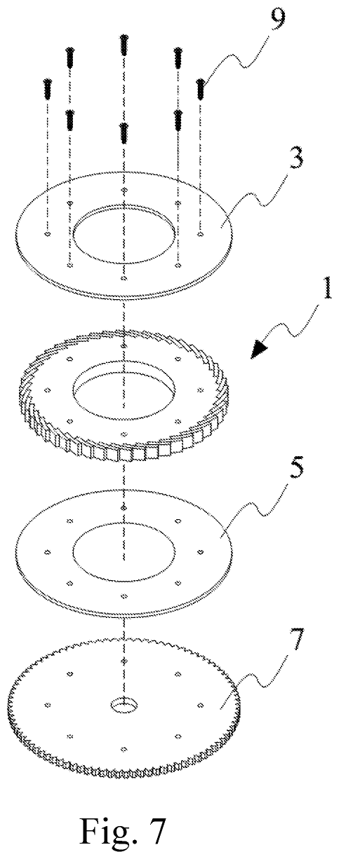

Please refer to FIG. 6 and FIG. 7 at the same time, FIG. 6 and FIG. 7 respectively show a three-dimensional view and a three-dimensional decomposition view of the magnetic rotor of the present invention. In order to achieve the main purpose of the present invention, the embodiment in FIG. 6 and FIG. 7 includes a magnetic rotary disc. As shown in the figures, according to one or more embodiments, the magnetic rotor 100 of the present invention is substantially composed of a magnetic rotary disc 1, a division plate 3, a division plate 5 and a transmission disc 7. The assemblies all have an axial hole aligned with the identical axis, which can be synchronously rotated according to the axial hole, and the assemblies are fixed together by a plurality of fixing elements 9 (exemplified as screws).

As mentioned above, the magnetic rotary disc 1 acts as a core assembly of the magnetic rotor 100, which has characteristics of permanent magnetism, and can generate a magnetic field with single magnetic pole and uniformly distributed. The division plate 3 and the division plate 5 are respectively arranged on the upper side and the lower side of the magnetic rotary disc 1, and the function thereof is to protect the magnetic rotary disc 1 while isolating the magnetic fields on the upper side and the lower side of the magnetic rotary disc 1, so as to limit the distribution of the magnetic fields in a plane while avoiding unnecessary magnetic balance off The transmission disc 7 is arranged on the lower side of the division plate 5, which has a plurality of transmission teethes arranged on the peripheral edge of the transmission substrate 7. Through the rotation of the transmission disc 7, the mechanical energy generated by the magnetic rotor 100 can effectively drive other electrical equipment.

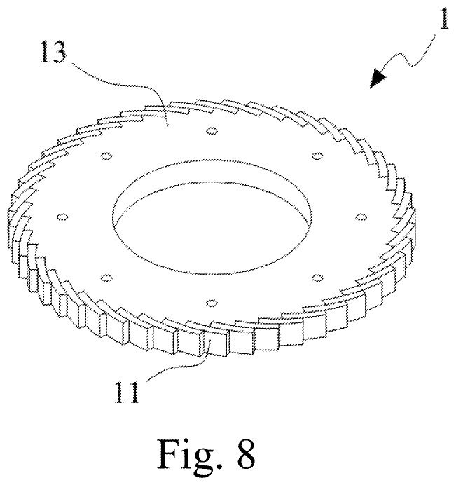

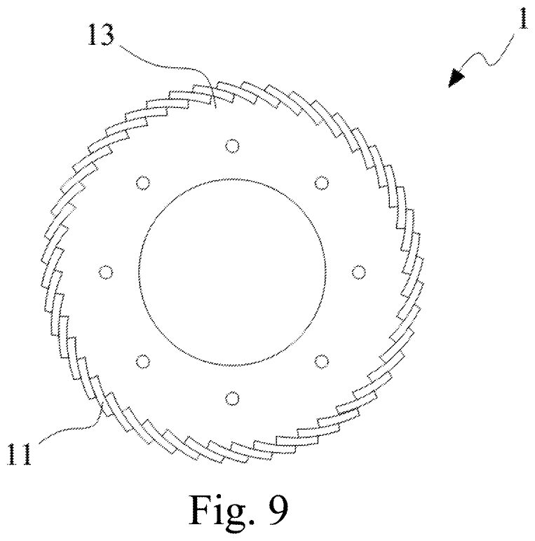

Please refer to FIG. 6 to FIG. 9 simultaneously, wherein FIG. 8 and FIG. 9 respectively show a three-dimensional view and a top view of the magnetic rotary disc of the present invention. As shown in the figures, according to one or more embodiments, the magnetic rotary disc 1 of the present invention is substantially composed of a metal rotary body 13 and a plurality of magnetic elements 11. The metal rotary body 13 is manufactured by metal (exemplified by iron), which may be in the form of a circular disc or a circular ring. The present invention is not limited to any foil ii herein, it may have any suitable appearance. The magnetic elements 11 are arranged on the peripheral edge of the metal rotary body 13 in a uniform distribution. The magnetic elements 11 can be directly attracted on the surface of the peripheral edge of the metal rotary body 13 without other media due to the metal rotary body 13 is formed of metal.

As mentioned above, the magnetic elements 11 can not only be directly attracted on the surface of the peripheral edge of the metal rotary body 13, but also can be attracted with each other in a way of being not completely overlapped. Accordingly, the magnetic elements 11 are arranged on the peripheral edge of the metal rotary body 13 in a uniform distribution. According to one or more embodiments, the magnetic elements 11 may be in the form of sheet structure having a curvature. Based on the presence of the curvature, the magnetic elements 11 can be more efficiently attracted to each other in a way of being not completely overlapped, and then arranged on the peripheral edge of the metal rotary body 13 in a uniform distribution. Similarly, the size of the curvature decides the amount of the magnetic elements 11. According to one or more embodiments, the amount of the magnetic elements 11 is 2×3 N or 6×N, wherein N is a positive integer between 1 and 16. Accordingly, the optimum range of the amount of the magnetic elements 11 is between 6 and 96.

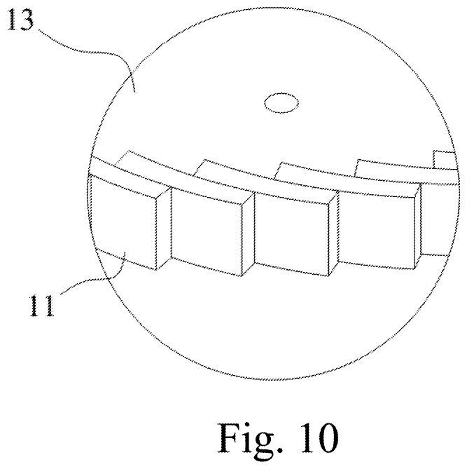

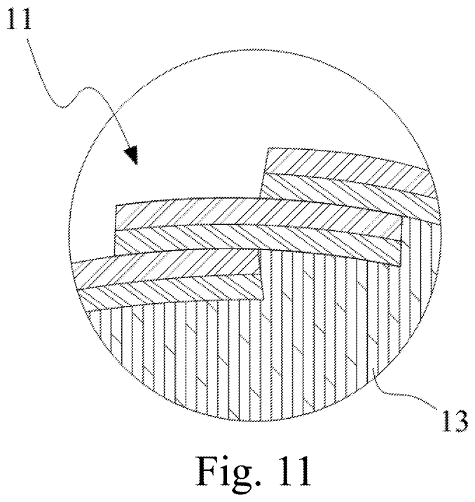

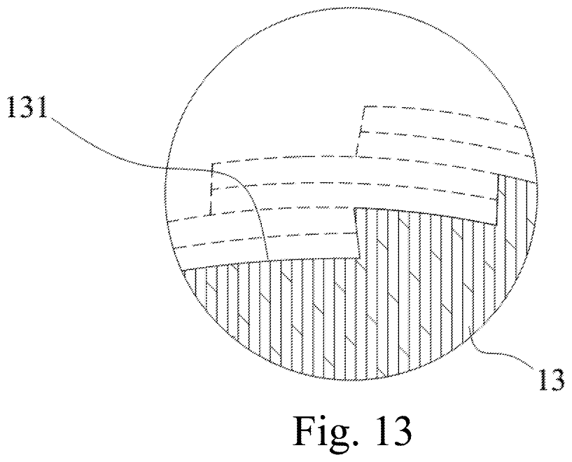

Please further refer to FIG. 10 to FIG. 13 simultaneously, wherein FIG. 10 shows the first partial three-dimensional view of the magnetic rotary disc of the present invention, and FIG. 11 to FIG. 13 respectively show the first to the third partial cross-sectional view of the magnetic rotary disc of the present invention. As shown in FIG. 11 and FIG. 13, according to one or more embodiments, the peripheral edge of the metal rotary body 13 of the present invention comprises a plurality of slots 131 in corresponding number, so that the adsorption of the magnetic elements 11 is provided. According to the foregoing, since according to the best embodiment of the present invention, the amount of the magnetic elements 11 is between 6 and 96, the amount of the slots 131 should also be between 6 and 96. With the arrangement of the slots 131, the magnetic elements 11 will be more firmly absorbed on the peripheral edge of the metal rotary body 13 in a uniform distribution, because these can be preset and completed. It is worth noting that the lower side of any magnetic elements 11 is not completely absorbed on the corresponding slots 131, because part of them is attracted on the upper side of the other magnetic elements 11.

As shown in FIG. 10 to FIG. 12, according to one or more embodiments, the magnetic elements 11 respectively comprises a first magnetic pole portion 111 and a second magnetic pole portion 113, wherein the first magnetic pole portions 111 and the second magnetic pole portions 113 respectively belong to upper portion and lower portion of the magnetic elements 11. According to one or more embodiments, the lower side of the second magnetic pole portion 113 of any magnetic elements 11 and the upper side of the first magnetic pole portion 111 of the other magnetic elements 11 partially attracted each other. Accordingly, only the magnetic force lines of the first magnetic pole portions 111 are retained outside the peripheral edge of the metal rotary body 13. According to the best embodiment of the present invention, the first magnetic pole portion 111 and the second magnetic pole portion 113 of the magnetic elements 11 respectively occupy to a half thereof, i.e., the shape and size of each magnetic elements 11 are the same and can be magnetized into the first magnetic pole portions 111 and the second magnetic pole portions 113 equally, both occupying half of them. Accordingly, the lower side of the second magnetic pole portions 113 of any magnetic elements 11 can half cover the upper side of the first magnetic pole portions 111 of the other magnetic elements 11, so as to implement that only the magnetic force lines of the first magnetic pole portions 111 are retained outside the peripheral edge of the metal rotary body 13.

It is worth mentioning that, according to one or more embodiments, the first magnetic pole portions 111 and the second magnetic pole portions 113 included in the magnetic elements 11 are not limited to any magnetic poles. In other words, if the first magnetic pole portions 111 are N pole, the second magnetic pole portions 113 are S pole, whereas if the first magnetic pole portions 111 are S pole, the second magnetic pole portions 113 are N pole. The keynote of the present invention is that, there are only the magnetic force lines distribution with single magnetic pole outside the peripheral edge of the metal rotary body 13, whether it is an N pole or an S pole. In addition, since the material of the metal rotary body 13 comprises metal iron and the magnetic elements 11 are directly attracted on the surface of the peripheral edge thereof, the magnetic field between the lower side of the magnetic elements 11 and the metal rotary body 13 will be balanced off. Similarly, the magnetic field between the lower side of the second magnetic pole portions 113 of any magnetic elements 11 and the upper side of the first magnetic pole portions 111 of the other magnetic elements 11 will be also balanced off.

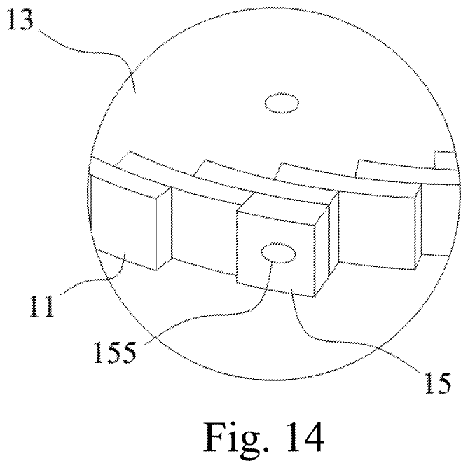

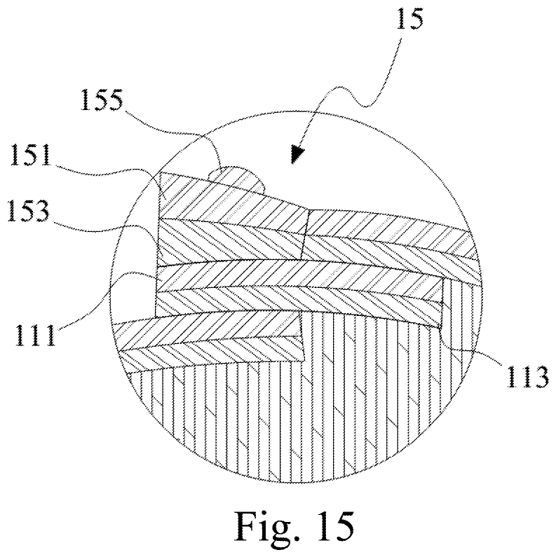

Please refer to FIG. 14 and FIG. 15, wherein FIG. 14 shows the second partial three-dimensional view of the magnetic rotary disc of the present invention, and FIG. 15 shows the fourth partial cross-sectional view of the magnetic rotary disc of the present invention. As shown in the figures, according to one or more embodiments, in order to make the concentration and reinforcement effect of the magnetic force lines better, the upper side of the first magnetic pole portion 111 of any magnetic elements 11 of each interval of a certain number, and an additional magnetic element 15 can also attract each other. According to one or more embodiments, the additional magnetic element 15 may also be in the form of sheet structure having a curvature. However, it should be noted that, the area of the additional magnetic element 15 should in principle be smaller than its attracted magnetic element 11, because the upper side of the first magnetic pole portion 111 of the attracted magnetic element 11 and the lower side of the second magnetic pole portion 113 of the other magnetic element 11 attract each other. Similarly, due to the amount of the magnetic elements 11 is between 6 and 96 in the best embodiment of the present invention, the upper side of the first magnetic pole portion 111 of the magnetic elements 11 of each interval of 6, and an additional magnetic element 15 can also attract with each other. Accordingly, the amount of the additional magnetic elements 15 could be between 1 and 16.

As shown in FIG. 15, according to one or more embodiments, the additional magnetic element 15 comprise a first magnetic pole portion 151 and a second magnetic pole portion 153. When the upper side of the first magnetic pole portions 111 of any magnetic elements 11 and the additional magnetic element 15 further attract with each other, the first magnetic pole portion 111 of the magnetic element 11 and the second magnetic pole portion 153 of the additional magnetic element 15 attract each other, and the magnetic field between them will be balanced off. Similarly, when the upper side of the first magnetic pole portions 111 of any magnetic elements 11 and the additional magnetic element 15 further attract with each other, the additional magnetic element 15 half cover the attracted first magnetic pole portions 111 of the magnetic elements 11, so as to implement that only the magnetic force lines of the first magnetic pole portions 111 and the first magnetic pole portion 151 are retained outside the peripheral edge of the metal rotary body 13, i.e., some of the first magnetic pole portions 111 will be covered by the additional magnetic element 15, and the magnetic force lines of the first magnetic pole portions 111 will be replaced with the magnetic force lines of the additional magnetic element 15.

As shown in FIG. 14 and FIG. 15, according to one or more embodiments, the first magnetic pole portions 151 of the additional magnetic elements 15 also respectively comprises a magnetic force concentration portion 155 and an inclined surface where the magnetic force concentration portion 155 is arranged on. The function of the additional magnetic force concentration portion 155 is to concentrate and strengthen the magnetic forces of the associated magnetic poles, and to make the magnetic forces of the magnetic poles more gradational and more directional, so that the magnetic poles interaction with the external magnetic field can be performed more efficiently. It is worth mentioning that, although the area of the additional magnetic elements 15 should in principle be smaller than its attracted magnetic elements 11, the thickness of thinner side of the additional magnetic elements 15 in the form of sheet structure should be equal to the magnetic elements 11 also in the form of sheet structure, so that the additional magnetic elements 15 will optimize the effect of the concentration and reinforcement of the magnetic forces. In a preferred embodiment, the magnetic field strength of the surface of the magnetic elements 15 ranges from 1000 to 15000 Gauss.

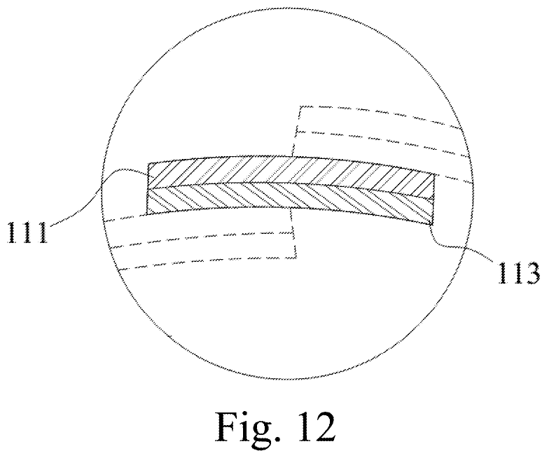

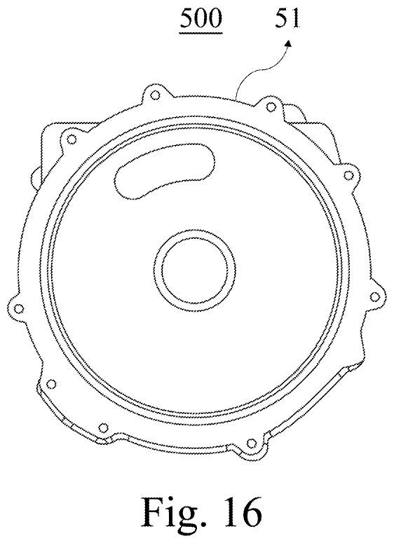

In an embodiment of the invention, please refer to both FIG. 6 and FIG. 12, which show the operation diagram of the magnetic rotor of the invention. The electric motor module 500, as shown in FIG. 16, including stator and rotor, is installed in the motor housing 51. The driving wheel 49 is coupled with the magnetic rotary disc 1, which drives the driving wheel 49 to rotate with the rotor through the magnetic rotary disc 1. During the rotation of magnetic rotary disc 1, the distribution of magnetic field lines around the rotor will be changed. Based on Lenz's law in electromagnetics, an induced electromotive force (EMF) ε can be generated by the stator in the direction of resisting the change of magnetic flux. Preferably, the voltage increment of the induced EMF ε can be increased by more than 0.5-4 times of the initial voltage V₀.

In addition, according to one or more embodiments, a plurality of guide rotors 200 may be arranged on outside the peripheral edge of the magnetic rotor 100. The guide rotors 200 are mainly composed of a magnetic guide element 21 and a transmission disc 27. The magnetic guide element 21 of the guide rotor 200 is provided corresponding to the magnetic elements 11 or the magnetic elements 15 of the magnetic rotor 100. There is magnetic poles interaction between them. Furthermore, the magnetic guide element 21 of the guide rotor 200 has an inclined surface corresponding to the magnetic force concentration portion 155 on the inclined surface of the magnetic elements 15, so as to optimize the interaction between the magnetic poles. When the magnetic rotor 100 rotates, the magnetic guide element 21 makes the tangent direction of the magnetic rotor 100 be continuously pushed forward during rotation according to the principle of same-polarity repulsion and opposite-polarity attraction, so as to achieve the ideal state that the magnetic rotor 100 can be approximately free from friction resistance during rotation, and thereby reducing the loss of mechanical energy of the magnetic rotor 100. The transmission disc 27 of the guide rotor 200 is provided corresponding to the transmission disc 7 of the magnetic rotor 100. They are engaged with each other.

It is worth mentioning that, the transmission disc 27 of the magnetic guide element 21 of the guide rotors 200 also has a plurality of transmission teethes, and the amount of the transmission teethes is equal to the amount of the transmission teethes of the transmission substrate 7 of the magnetic rotor 100, so as to be synchronously rotated. Through the interaction between the transmission disc 27 of the guide rotor 200 and the magnetic rotor 100, the magnetic rotor 100 only needs extremely small electric energy supply, then high-efficiency magnetic poles interaction with the guide rotor 200 can be achieved, so as to perform smooth and high-speed rotary motion. Therefore, through the magnetic rotor 100 provided by the present invention, it is only required a very small amount of electric energy to generate a great amount of mechanical energy, and the mechanical energy can generate electric energy more efficiently, thereby implementing the new concept of “Power and Power Cogeneration”.

In the description above, for the purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form. There may be intermediate structure between illustrated components. The components described or illustrated herein may have additional inputs or outputs that are not illustrated or described. The illustrated elements or components may also be arranged in different arrangements or orders, including the reordering of any fields or the modification of field sizes.

An embodiment is an implementation or example of the invention. Reference in the specification to “an embodiment”, “one embodiment”, “some embodiments”, or “other embodiments” means that a particular feature, structure, or characteristic described in connection with the embodiments is included in at least some embodiments, but not necessarily all embodiments. The various appearances of “an embodiment”, “one embodiment”, “some embodiments”, or “other embodiments” are not necessarily all referring to the same embodiments. It should be appreciated that in the foregoing description of exemplary embodiments of the invention, various features of the invention are sometimes grouped together in a single embodiment, figure, or description thereof for the purpose of streamlining the disclosure and aiding in the understanding of one or more of the various inventive aspects.

The present invention truly has novelty, inventive step and industrial applicability, and the patent application requirements stipulated in the patent law should be undoubted. Therefore, an application for patent of invention shall be filed according to the patent law. We sincerely and gratefully pray for the grant of patent from the Bureau as soon as possible.

1. A magnetoelectric energy conversion device, comprising:
a control module to control an operation of said magnetoelectric energy conversion device;
a magnetic rotor a coupled to said control module, wherein said magnetic rotor includes a magnetic rotary disc including a metal rotary body and a plurality of magnetic elements arranged on peripheral edge of said magnetic rotor in a uniform distribution, wherein each of said plurality of magnetic elements includes a first magnetic pole portion and a second magnetic pole portion located an upper portion and a lower portion thereof, and magnetic force lines of said first magnetic pole portion are retained outside of said peripheral edge of said metal rotary body;
a plurality of guide rotors disposed on outside of said peripheral edge of said magnetic rotor, wherein said plurality of guide rotors includes a magnetic guide element interacting with said first magnetic pole portion;
a flywheel module coupled to said magnetic rotor;
a drive shaft module to transmit mechanical energy of said magnetic rotor; and
an electric motor module coupled to said drive shaft module, generating an induced electromotive force by said mechanical energy of said magnetic rotor.

2. The device of claim 1, further comprising a driving motor module coupled to said flywheel module, wherein said flywheel module includes at least one flywheel, a transmission disc and a rotating shaft, wherein said at least one flywheel is arranged on said rotating shaft in a concentric structure, and said transmission disc is arranged on an upper end of said at least one flywheel to reduce an operation error caused by vibration of said magnetic rotor.

3. The device of claim 1, wherein said plurality of guide rotors include a transmission disc, and said magnetic guide element has an inclined plane to reduce mechanical energy consumption of said magnetic rotor in operation.

4. The device of claim 1, wherein said drive shaft module comprises a gear, and a drive shaft is connected with said gear and a drive wheel, when said gear is driven by said flywheel module, mechanical energy is transmitted to said drive wheel through said drive shaft.

5. The device of claim 1, wherein said peripheral edge of said metal rotary body comprises a plurality of slots.

6. The device of claim 1, wherein an amount of said magnetic elements is 6×N, wherein N is a positive integer between 1 and 16.

7. The device of claim 1, wherein said magnetic elements have a sheet structure with a curvature.

8. The device of claim 1, wherein said second magnetic pole portion is S pole and said first magnetic pole portion is N pole, whereas said second magnetic pole portion is N pole and said first magnetic pole portion is S pole.

9. The device of claim 1, wherein an upper side of said first magnetic pole portion of any one of said magnetic elements can attract with an additional magnetic element, so as to concentrate magnetic force nearby.

10. The device of claim 9, wherein a first magnetic pole portion of said additional magnetic element further comprises a magnetic force concentration portion and an inclined plane, wherein said magnetic force concentration portion is arranged on said inclined plane.

11. A magnetoelectric energy conversion device, comprising:
a control module coupled to said driving motor module to control an operation of said driving motor module;
a magnetic rotor a coupled to said control module, wherein said magnetic rotor includes a magnetic rotary disc including a metal rotary body and a plurality of magnetic elements arranged on peripheral edge of said magnetic rotor in a uniform distribution, wherein each of said plurality of magnetic elements includes a first magnetic pole portion and a second magnetic pole portion located an upper portion and a lower portion thereof, and magnetic force lines of said first magnetic pole portion are retained outside of said peripheral edge of said metal rotary body;
a plurality of guide rotors disposed on outside of said peripheral edge of said magnetic rotor, wherein said plurality of guide rotors includes a magnetic guide element interacting with said first magnetic pole portion;
a flywheel module coupled to said magnetic rotor;
a drive shaft module to transmit mechanical energy of said magnetic rotor;
an electric motor module coupled to said drive shaft module, generating an induced electromotive force by said mechanical energy of said magnetic rotor; and
a high-low voltage power supply coupled to said electric motor module to provide a high voltage power and a low voltage power to a first battery and a second battery in timing mutually switching.

12. (canceled)

13. The device of claim 11, further comprising a switch coupled to said first battery and said second battery.

14. The device of claim 11, wherein said high-low voltage power supply includes a booster and a voltage regulator coupled to said booster.

15. The device of claim 11, wherein said driving motor module is coupled to said flywheel module, wherein said flywheel module includes at least one flywheel, a transmission disc and a rotating shaft, wherein said at least one flywheel is arranged on said rotating shaft in a concentric structure, and said transmission disc is arranged on an upper end of said at least one flywheel to reduce an operation error caused by vibration of said magnetic rotor.

16. The device of claim 11, wherein said plurality of guide rotors include a transmission disc, and said magnetic guide element has an inclined plane to reduce mechanical energy consumption of said magnetic rotor in operation.

17. The device of claim 11, wherein said drive shaft module comprises a gear, and a drive shaft is connected with said gear and a drive wheel, when said gear is driven by said flywheel module, mechanical energy is transmitted to said drive wheel through said drive shaft.

18. The device of claim 11, wherein said peripheral edge of said metal rotary body comprises a plurality of slots.

19. The device of claim 11, wherein an upper side of said first magnetic pole portion of any one of said magnetic elements can attract with an additional magnetic element, so as to concentrate magnetic force nearby.

20. The device of claim 19, wherein a first magnetic pole portion of said additional magnetic element further comprises a magnetic force concentration portion and an inclined plane, wherein said magnetic force concentration portion is arranged on said inclined plane.

21. The device of claim 14, wherein said booster is a motor-booster.
